(19) United States
(12) Patent Application Publication
(10) Pub. No.: US 2008/0010536 A1
(43) Pub. Date: Jan. 10, 2008

(54) Breakpoints with Separate Conditions

(76) Inventors: Cary Lee Bates, Rochester, MN (US); Jason J. Illg, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/423,490

(22) Filed: Jun. 12, 2006

(51) Int. Cl. G06F 11/00

(52) U.S. Cl. 714/38

(57) ABSTRACT

In an embodiment, a determination is made whether a breakpoint command identifies a breakpoint location, a condition expression, and a condition location with the condition location separate from the breakpoint location. If the determination is true and execution of a program reaches the condition location, the condition expression is evaluated at the condition location, and a result of the condition expression is saved and associated with the breakpoint location. In response to execution of the program reaching the breakpoint location, if the result exists and is associated with the breakpoint location, the execution of the program is halted at the breakpoint location. But, if the result is false, the program is allowed to continue executing at the breakpoint location. In various embodiments, the condition expression may include a variable that is out-of-scope at the breakpoint location, or an identification of a storage location that is unaddressable while execution of the program is at the breakpoint location, but addressable while execution of the program is at the condition location.

### FIELD

An embodiment of the invention generally relates to debugging computer programs. In particular, an embodiment of the invention generally relates to breakpoints with a condition that is evaluated at a separate location from the breakpoint location.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are much more powerful than just a few years ago.

As the sophistication and complexity of computer software increase, the software becomes more difficult to debug. Bugs are problems, faults, or errors in a computer program. Locating, analyzing, and correcting suspected faults in a computer program is a process known as “debugging.” Typically, a programmer uses another computer program commonly known as a “debugger” to debug the program under development.

Conventional debuggers typically support two primary operations to assist a computer programmer. A first operation supported by conventional debuggers is a “step” function, which permits a computer programmer to process instructions (also known as “statements”) in a computer program one-by-one and see the results upon completion of each instruction. While the step operation provides a programmer with a large amount of information about a program during its execution, stepping through hundreds or thousands of program instructions can be extremely tedious and time consuming and may require the programmer to step through many program instructions that are known to be error-free before a set of instructions to be analyzed is finally executed.

To address this difficulty, a second operation supported by conventional debuggers is a breakpoint operation, which permits a computer programmer to identify with a breakpoint a precise instruction at which to halt execution of a computer program during execution. As a result, when a computer program is executed by a debugger, the program executes in a normal fashion until the breakpoint is reached. The debugger then stops execution of the program and displays the results of the program and/or the state of the computer system to the programmer for analysis, typically via a debugger user interface.

Typically, step operations and breakpoints are used together to simplify the debugging process. Specifically, a common debugging operation is to set a breakpoint at the beginning of a desired set of instructions to be analyzed and then begin executing the program. Once the breakpoint is reached, the debugger halts the program, and the programmer then steps through the desired set of instructions line-by-line using the step operation. Consequently, a programmer is able to more quickly isolate and analyze a particular set of instructions without needing to step through irrelevant portions of a computer program.

Some conventional debuggers support conditional breakpoints, which allow the user to set a breakpoint that fires only if a program variable achieves a certain value. For example, consider a standard “for loop” that increments the variable “i” once during each loop iteration. Conditional breakpoints allow the user to set a breakpoint that fires or causes execution of the program to halt when the current value of “i” is greater than or equal to a certain value, e.g., 10. While conditional breakpoints can be useful, they have the problem that the variables that a user desires to add to the condition might not be addressable or may no longer contain the values of interest at the location in the program where the user desires to set the conditional breakpoint. For example, a variable that is local to one procedure, module, or method is not necessarily in scope, active, addressable, or accessible by another procedure, module, or method.

In an attempt to work around this problem, a user might set a conditional breakpoint at a first location where the desired variable is addressable. Once the conditional breakpoint fires, the user must manually step to a second program location in which the user is interested. This manual process is cumbersome and error prone.

What is needed is a better way to handle conditional breakpoints.

### SUMMARY

A method, apparatus, system, and signal-bearing medium are provided. In an embodiment, a determination is made whether a breakpoint command identifies a breakpoint location, a condition expression, and a condition location with the condition location separate from the breakpoint location. If the determination is true and execution of a program reaches the condition location, the condition expression is evaluated at the condition location, and a result of the condition expression is saved and associated with the breakpoint location. In response to execution of the program reaching the breakpoint location, if the result exists and is associated with the breakpoint location, the execution of the program is halted at the breakpoint location. But, if the result is false, the program is allowed to continue executing at the breakpoint location. In various embodiments, the condition expression may include a variable that is out-of-scope at the breakpoint location, or an identification of a storage location that is unaddressable while execution of the program is at the breakpoint location, but addressable while execution of the program is at the condition location.

### BRIEF DESCRIPTION OF THE DRAWING

Various embodiments of the present invention are hereinafter described in conjunction with the appended drawings:

FIG. 1 depicts a block diagram of an example system for implementing an embodiment of the invention.

FIG. 2 depicts a block diagram of an example debug user interface, according to an embodiment of the invention.

FIG. 3 depicts a block diagram of example debug commands, according to an embodiment of the invention.

FIG. 4 depicts a block diagram of an example breakpoint table, according to an embodiment of the invention.

FIG. 5 depicts a flowchart of example processing for a debugger, according to an embodiment of the invention.

FIG. 6 depicts a flowchart of further example processing for a debugger, according to an embodiment of the invention.

FIG. 7 depicts a flowchart of further example processing for a debugger, according to an embodiment of the invention.

FIG. 8 depicts a flowchart of further example processing for a debugger, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

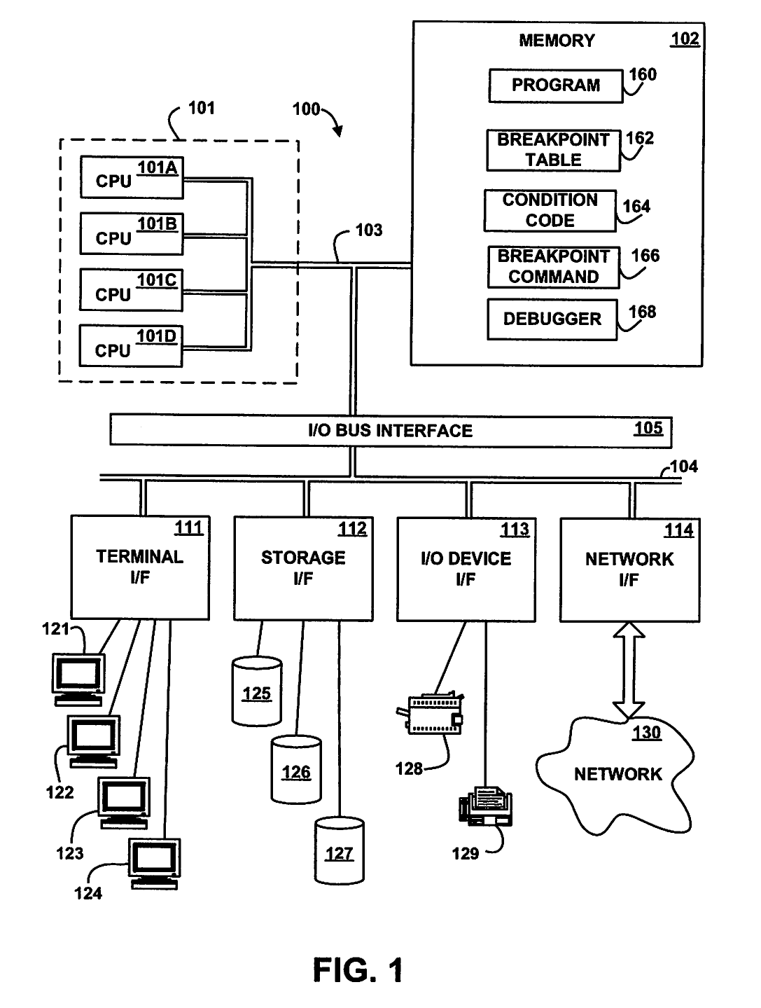

Referring to the Drawings, wherein like numbers denote like parts throughout the several views, FIG. 1 depicts a high-level block diagram representation of a computer system 100 connected to a network 130, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as a processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes, stores, or is encoded with a program 160, a breakpoint table 162, condition code 164, a breakpoint command 166, and a debugger 168. Although the program 160, the breakpoint table 162, the condition code 164, the breakpoint command 166, and the debugger 168 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the program 160, the breakpoint table 162, the condition code 164, the breakpoint command 166, and the debugger 168 are illustrated as being contained within the main memory 102, these elements are not necessarily all completely contained in the same storage device at the same time. Further, although the program 160, the breakpoint table 162, the condition code 164, the breakpoint command 166, and the debugger 168 are illustrated as being separate entities, in other embodiments some of them, or portions of some of them, may be packaged together.

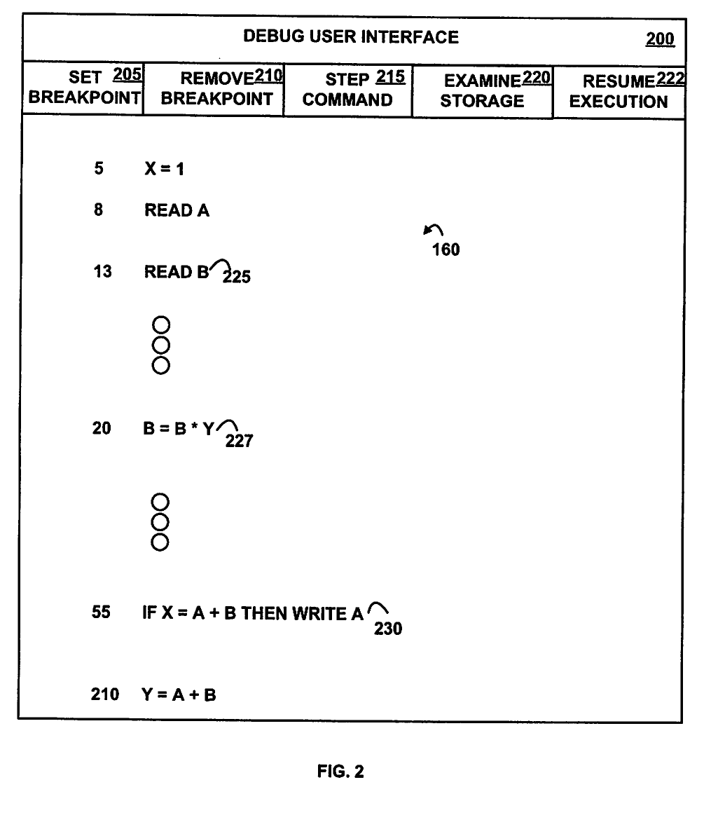

The program 160 is a program being debugged by the debugger 168. The program 160 may include object code instructions capable of executing on the processor 101, source code statements capable of being compiled into object code instructions, source code statements capable of being interpreted to execute on the processor 101, intermediate byte codes capable of being executed on the processor 101, any other appropriate type of program, or any multiple, combination, or portion thereof. In various embodiments, the program 160 may be an application program, an operating system program, a user application, a third party application, or any other type of program. The program 160 is further described below with reference to FIG. 2.

The debugger 168 manages breakpoints in the program 160 in response to receiving a breakpoint command 166, which may be issued on a command line, entered through a graphical user interface, or issued via an application. A breakpoint is an instruction at which the user desires to halt execution of the program 160. As a result, when the program 160 is executed by the debugger 168, the program 160 executes in a normal fashion until the breakpoint is reached. The debugger 168 then stops execution of the program 160 and displays the results of the program 160 and/or the state of the computer system to the programmer for analysis, typically via a debugger user interface.

The debugger 168 sets breakpoints in the program 160, e.g., by replacing a valid instruction at a breakpoint location in the program 160 with an invalid instruction and by creating a record for the breakpoint in the breakpoint table 162 (further described below with reference to FIG. 4). After the breakpoints are set, the user provides an input to a debug user interface that resumes execution of the program 160. When execution of the program 160 eventually encounters the invalid instruction, a system exception or interrupt occurs, which gives control to the debugger 168. The debugger 168 then optionally executes the condition code 164. The debugger 168 uses the condition code 164 and the breakpoint table 162 to decide whether to give control to the user via a debug user interface or to resume execution of the program 160 without giving control to the user. If the debugger 168 gives control to the user via a debug user interface, the user may then issue commands to the debugger 168, which the debugger 168 interprets to execute instruction(s) in the program 160, display variables, parameters, program status, storage locations, or registers, set or remove breakpoints, resume execution of the program 160, or any other appropriate operations.

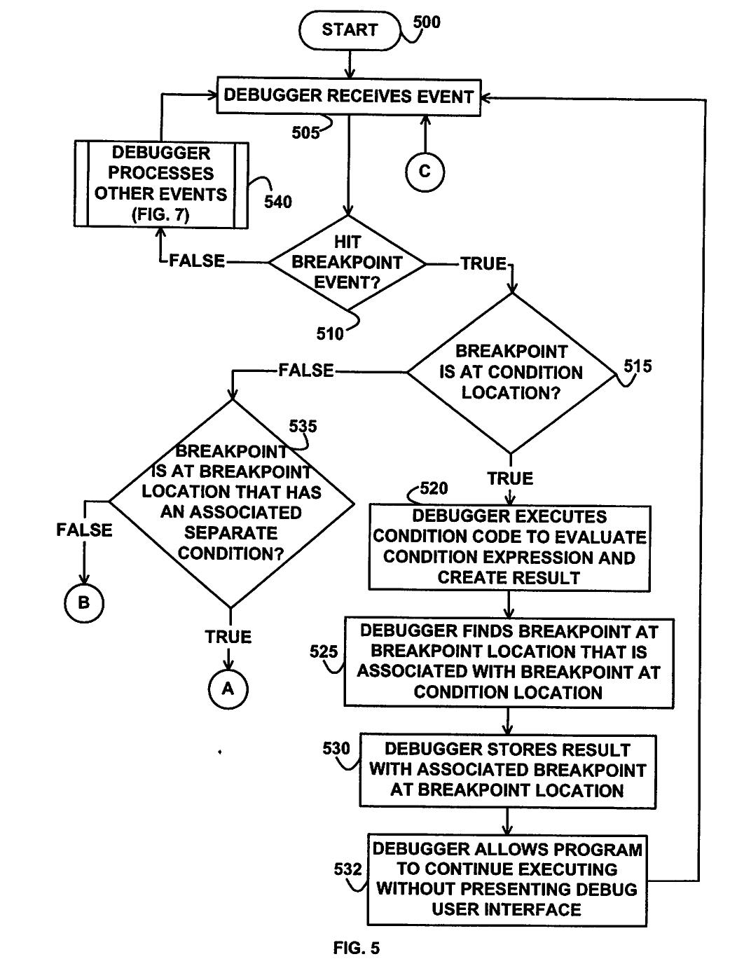

In an embodiment, the debugger 168 include instructions capable of executing on the processor 101 or statements capable of being interpreted by instructions executing on the processor 101 to perform the functions as further described below with reference to FIGS. 5, 6, 7, and 8. In another embodiment, the debugger 168 may be implemented in microcode. In another embodiment, the debugger 168 may be implemented in hardware via logic gates and/or other appropriate hardware techniques.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127.

The I/O device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

It should be understood that FIG. 1 is intended to depict the representative major components of the computer system 100 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of tangible signal-bearing media that may be operatively or communicatively connected (directly or indirectly) to the processor 101. The signal-bearing media may include, but are not limited to:

(1) information permanently stored on a non-rewriteable storage medium, e.g., a read-only memory device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or (3) information conveyed by a communications medium, such as through a computer or a telephone network, e.g., the network 130.

Such tangible signal-bearing media, when carrying or encoded with computer-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of an example debug user interface 200, according to an embodiment of the invention. In an embodiment, the debugger 168 displays the debug user interface 200 on one or more of the terminals 121, 122, 123, or 124, but in other embodiments, the debugger 168 may present the debug user interface 200 via the printer 128, a speaker, or any other appropriate output device.

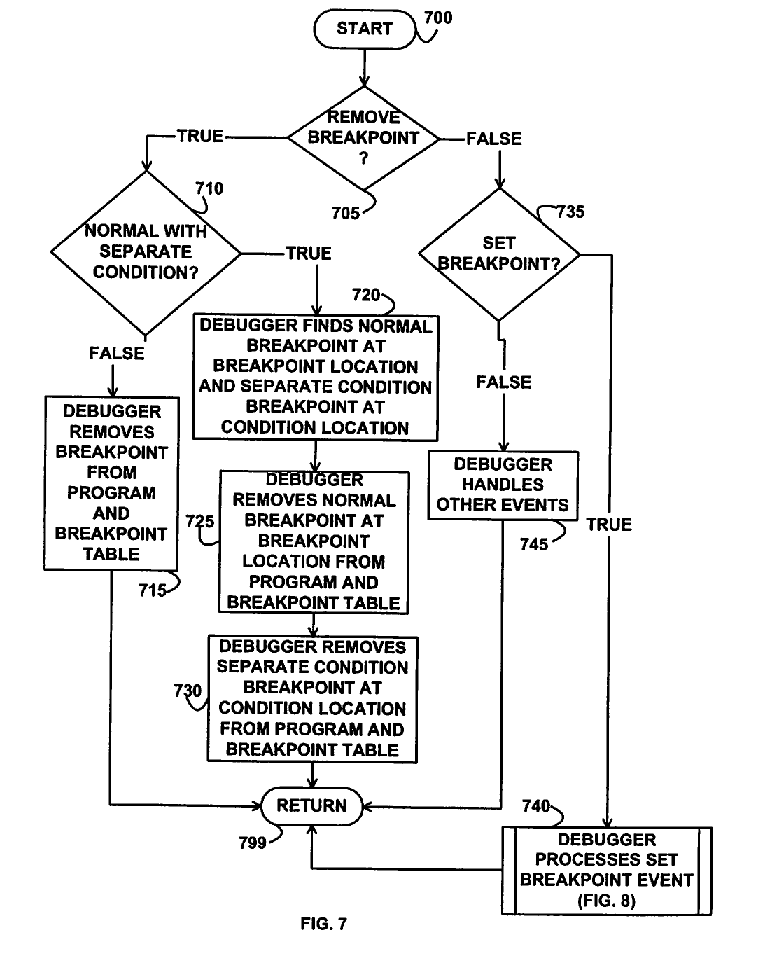

The debug user interface 200 includes a presentation of the program 160, a set breakpoint command option 205, a remove breakpoint command option 210, a step command option 215, an examine storage command option 220, and a resume execution command option 222, but in other embodiments any appropriate command options may be present. In response to the set breakpoint command 205, the debugger 168 sets breakpoints in the program 160, as further described below with reference to FIGS. 7. and 8. In response to the remove breakpoint command 210, the debugger 168 removes breakpoints from the program 160, as further described below with reference to FIG. 7. In response to the step command 215, the debugger 168 causes one or more statements or instructions in the program 160 to execute on the processor 101. In response to the examine storage command 220, the debugger 168 displays variables, parameters, program status, program stacks, registers, or any other type of data or storage locations. In response to the resume execution command 222, the debugger 168 resumes execution of the program 160 on the processor 101.

The program 160 includes a breakpoint location 230 and a condition location 225, which is a separate (different) location from the breakpoint location 230. The breakpoint location 230 is a location, statement or instruction in the program 160 at which a breakpoint is set by the debugger 168 in response to a breakpoint command 166. The condition location 225 is the location, statement, or instruction in the program 160 at which the execution of the program 160 is temporarily stopped while the debugger 168 evaluates whether a condition is true, in order to determine whether to later halt the execution of the program 160 when the execution of the program 160 reaches or encounters the breakpoint location 230. The condition location 225 is a separate (different) location in the program 160 from the breakpoint location 230, so the debugger 168 evaluates the condition at a separate (different) location in the program 160 from the location at which the program 160 is to halt, so the condition is separated from the breakpoint that the condition controls. The condition location 225 is separated from the breakpoint location 230 both in terms of location within the program 160 and in terms of the execution time at which execution of the program 160 reaches or encounters the separate locations.

The program 160 further includes an intervening location 227. The statement or instruction at the intervening location 227 is executed by execution of the program 160 at a time that intervenes (is in between) the time that the statement or instruction at the condition location 225 executes and the time that the statement or instruction at the breakpoint location 230 executes. Thus, if the statement or instruction (when executed) at the intervening location 227 modifies a value or a variable used by a condition that the debugger 168 evaluates at the condition location 225, then the truth or falsehood of the condition is not necessarily the same at the condition location 225 and the breakpoint location 230. For example, if the statement at the condition location 225 executes first in time, the statement at the intervening location 227 executes second in time, the statement at the breakpoint location 230 executes third in time, and the condition evaluated by the debugger 168 while execution of the program 168 is at the condition location 225 is “A<B,” then the truth or falsehood of the condition “A<B” is not necessarily the same at the condition location 225 as it is at the breakpoint location 230 because the execution of the program 160 at the intervening location 227 modifies the value of the variable “B,” which might change the truth or falsehood of the condition “A<B,” depending on the values of the variables “A” and “B.”

Some or all of the condition location 225, the intervening location 227, and the breakpoint location 230 may be in different procedures, modules, methods, routines and may be present on the same computer system or distributed across different computer systems. Further, the storage locations of the condition location 225, the intervening location 227, and the breakpoint location 230 may be present in any order within the program 160.

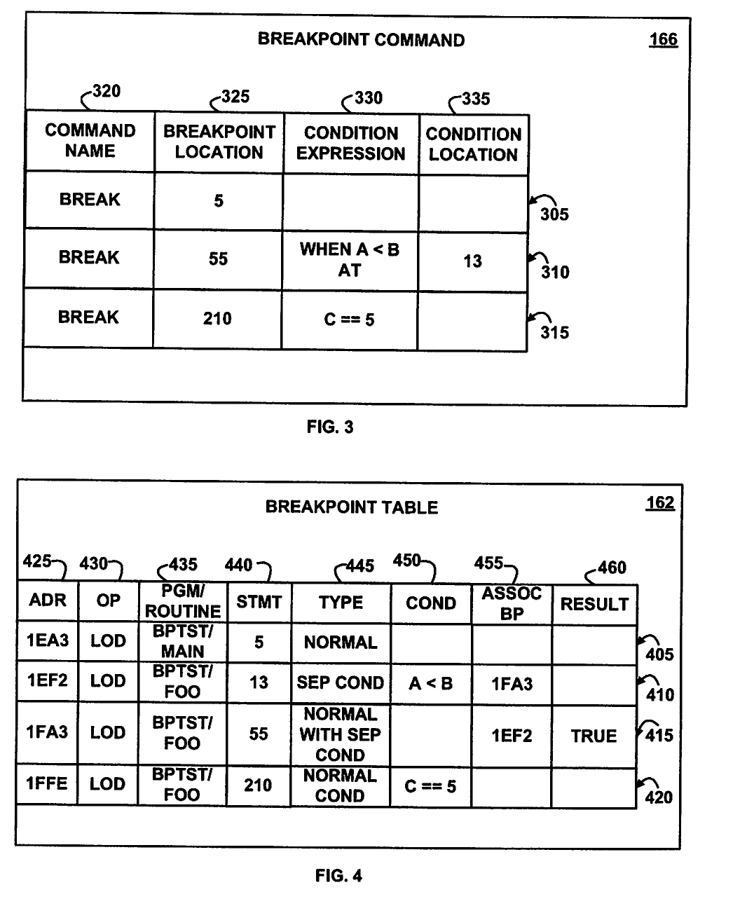

FIG. 3 depicts a block diagram of example breakpoint commands 166, according to an embodiment of the invention. The breakpoint commands 166 include example commands 305, 310, and 315. The breakpoint commands 166 may be entered via a command line, via a graphical user interface (such as the set breakpoint command 205 of the debug user interface 200), via a program, or via any other appropriate technique.

The breakpoint command 305 includes a command name 320 that identifies the command as a breakpoint command and a breakpoint location 325. The breakpoint command 305 is a normal breakpoint command in that it requests the debugger 168 to unconditionally halt the execution of the program 160 and give control of the program 160 to the user via the debug user interface 200, in response to the execution of the program 160 encountering or reaching the breakpoint location 325.

The breakpoint command 310 includes a command name 320 that identifies the command as a breakpoint command, a breakpoint location 325, a condition expression 330, and a condition location 335. The breakpoint command 310 is a conditional breakpoint command with a condition location 335 that is separate from the breakpoint location 325, in that the breakpoint command 310 requests the debugger 168 to conditionally halt the execution of the program 160 at the breakpoint location 325 and give control of the program 160 to the user via the debug user interface 200, in response to the execution of the program 160 reaching the breakpoint location 325 if the condition expression 330 is true while the execution of the program 160 is at the condition location 335. If the condition expression 330 evaluates to false at the condition location 335, then the debugger 168 does not give control of the program 160 to the user via the debug user interface 200 when the execution of the program 160 encounters the breakpoint location 325 Thus, the debugger 168 evaluates the condition expression 330 at a different location (the condition location 335) from the breakpoint location 325.

In various embodiments, the condition expression 330 may include a variable that is out-of-scope or inactive at the breakpoint location 325 or an identification of a storage location that is unaddressable while execution of the program 160 is at the breakpoint location 325, but addressable while execution of the program 160 is at the condition location 335.

In another embodiment, the condition expression 330 includes a variable that contains a value of interest (to the user setting the breakpoint) at the condition location 335, but does not necessarily contain the value of interest at the breakpoint location 325. For example, the value in the variable that existed while execution of the program 160 was located at the condition location 335 may be destroyed or overwritten by the operation of the execution of the program 160 between the time that execution was at the condition location 335 and the time that execution reaches the breakpoint location 325 by operation of a statement or instruction at the intervening location 227. Thus, in an embodiment, the user that is debugging the program 160 via the condition expression 330 is interested in the value that is stored in the variable while execution of the program 160 is located at the condition location 335, but is not interested in the value that is stored in the variable while execution of the program 160 is located at the breakpoint location 325, at least for the purpose of deciding (via the debugger 168 evaluating the truth or falsehood of the condition expression 330) whether or not to halt execution of the program 160 at the breakpoint location 325.

In an embodiment, the breakpoint location 325 and/or the condition location 335 may identify high-level language (HLL) references in the program 160, such as line or statement numbers or software object references such as a program or module name, from which the physical storage address may be cross referenced. In another embodiment, the breakpoint location 325 and/or the condition location 335 may indicate low-level instructions in the program 160. Using the example debug user interface 200 of FIG. 2, the condition location 335 in the breakpoint command 310 identifies the example condition location 225, and the breakpoint location 325 in the breakpoint command 310 identifies the example breakpoint location 230.

The breakpoint command 315 includes a command name 320 that identifies the command as a breakpoint command, a breakpoint location 325, a condition expression 330, but not a condition location 335. Thus, the breakpoint command 315 is a conditional breakpoint, and the debugger 168 evaluates the condition expression 330 for truth or falsehood at the time that the program execution is at the breakpoint location 325. If the condition expression 330 is true while the program execution is at the breakpoint location 325, then the debugger 168 halts the program 160 and gives control to the user via the debug user interface 200. But, if the condition expression 330 is false while the program execution is at the breakpoint location 325, then the debugger 168 does not give control the user and instead resumes or continues execution of the program 160.

FIG. 4 depicts a block diagram of a breakpoint table 162, according to an embodiment of the invention. The breakpoint table 162 includes example records 405, 410, 415, and 420, each of which includes an address field 425, an operation field 430, a program field 435, a statement field 440, a type field 445, a condition field 450, an associated breakpoint field 455, and a result field 460. Each of the breakpoint records 405, 410, 415, and 420 represents a breakpoint that the debugger 168 has set in the program 160.

The address field 425 identifies the address in the program 160 at which the breakpoint is set. The operation field 430 represents the operation or instruction that was at the address field 425 in the program 160 prior to the debugger 168 replacing the operation 430 with an invalid instruction. The debugger 168 replaces the invalid operation at the address 425 with the operation 430 prior to resuming execution of the program 160 subsequent to encountering the breakpoint. The program field 435 identifies the program 160, the method, the procedure, the routine, the library, the directory, and/or the subdirectory that contains the address 425. The statement field 440 identifies a high-level statement in the program 160 that corresponds to the low-level address 425 and/or operation 430. A statement 440 may have multiple addresses 425 and operations 430 that implement the statement 440.

The type field 445 indicates the type of the breakpoint, such as a normal breakpoint (record 405), a breakpoint for a separate condition (record 410), a normal breakpoint that has a separate condition (record 415), and a normal conditional breakpoint (record 420).

The condition field 450 identifies the condition expression 330 associated with a conditional breakpoint that the debugger 168 evaluates to decide whether to halt the program 160 and give control to the user via a debug user interface 200. In another embodiment, the condition field 450 identifies the condition code 164 that the debugger 168 executes or evaluates in response to encountering the breakpoint identified by the record, in order to make the decision of whether to halt the program 160. In the record 410, the condition 450 identifies a condition expression 330 or condition code 164 that the debugger 168 executes or evaluates upon encountering the breakpoint at the address 425 of “1EF2.”

The associated breakpoint field 455 identifies the another breakpoint to which the record is associated. For example, the associated breakpoint field 455 in the record 410 contains “1FA3,” which identifies the record 415, which has the same value “1FA3” in its address field 425. As another example, the associated breakpoint field 455 in the record 415 contains “1EF2,” which identifies the record 410, which has the same value “1EF2” in its address field 425. In other embodiments, the associated breakpoint field 455 may include a record number that identifies the corresponding record in the breakpoint table 162 or any other technique for identifying an associated breakpoint. The records 410 and 415 are associated because the record 410 represents a separate condition for the breakpoint of the record 415. The result field 460 in the record 415 indicates the result (the truth or falsehood) of the evaluation of the condition 450 in the record 410.

The debugger 168 creates the record 405 in response to the breakpoint command 305 (FIG. 3). The debugger 168 creates the records 410 and 415 in response to the breakpoint command 310 (FIG. 3). The debugger 168 creates the record 410 to correspond to a breakpoint at the condition location 335, although the user is not given control via the user interface 200 when execution of the program encounters the condition location 335. The debugger 168 creates the record 415 to correspond to a breakpoint at the breakpoint location 325. The debugger 168 creates the record 420 in response to the breakpoint command 315 (FIG. 3).

For a type 445 of normal breakpoint (e.g., the record 405), the address 425, program 435, and statement 440 identify a breakpoint location, and the debugger 168 halts execution of the program 160 unconditionally in response to the execution of the program 160 encountering the breakpoint location 325.

For a type 445 of separate condition (e.g., the record 410), the address 425, program 435, and statement 440 identify a condition location 335, and the debugger 168 evaluates the condition 450 in response to the execution of the program 160 encountering the condition location 335. The debugger 168 further finds the breakpoint record (e.g., the record 415) associated with the separate condition via the associated breakpoint field 455 and stores the result (the truth or falsehood) of the condition 450 in the result 460 of the associated breakpoint record (e.g., the record 415). The debugger 168 then resumes execution of the program 160 without giving control to the user via the debug user interface 200 because the type 445 indicates a separate condition.

For a type 445 of normal breakpoint with a separate condition (e.g., the record 415), the address 425, program 435, and statement 440 identify a breakpoint location 325, and the debugger 168 evaluates the truth or falsehood of the result 460 in response to the execution of the program 160 encountering the breakpoint location 325. If the result 460 is true, the debugger 168 halts execution of the program 160 and gives control to the user via the debug user interface 200. If the result 460 is false, the debugger 168 resumes execution of the program 160 without giving control to the user via the debug user interface 200.

For a type 445 of normal condition (e.g., the record 420), the address 425, the program 435, and statement 440 identify a breakpoint location 325, and the debugger 168 evaluates the condition 450 in response to the execution of the program 160 encountering the breakpoint location 325. If the condition 450 evaluates to true, the debugger 168 halts execution of the program 160 and gives control to the user via the debug user interface 200. If the condition 450 evaluates to false, the debugger 168 resumes execution of the program 160 without giving control to the user via the debug user interface 200.

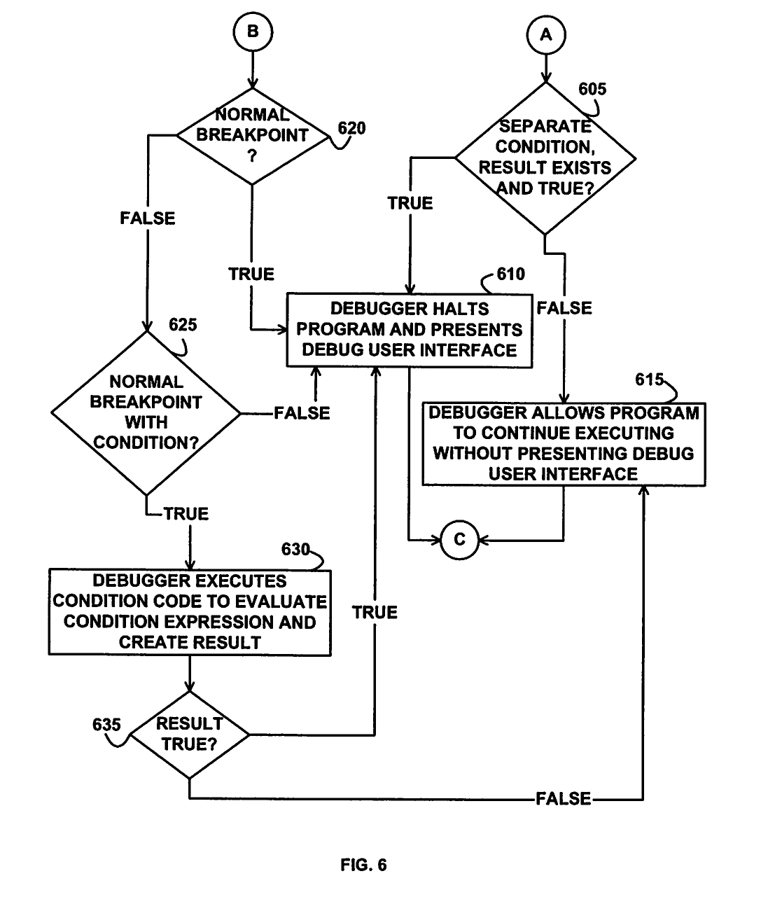

FIGS. 5 and 6 depict flowcharts for processing for the debugger 168, according to an embodiment of the invention. Control begins at block 500. Control then continues to block 505 where the debugger 168 receives an event. Control then continues to block 510 where the debugger 168 determines whether the received event is a hit breakpoint event. A hit breakpoint event occurs in response to execution of the program 160 on the processor 101 encountering or hitting a breakpoint, such as an invalid instruction that causes a system exception, giving control to the debugger 168.

If the determination at block 510 is true, then the received event is a hit breakpoint event, so control continues to block 515 where the debugger 168 determines whether the breakpoint that was hit, reached, or encountered by the execution of the program 160 is located at the condition location 335. The debugger 168 makes the determination of block 515 by finding a record in the breakpoint table 162 with an address field 425 and program/routine field 435 whose contents match the address of the instruction in the program 160 that caused the received breakpoint event. The debugger 168 further makes the determination of block 515 by determining whether the found breakpoint table record has a type field 445 that indicates that the address 425 represents a separate condition location 335.

If the determination at block 515 is true, then execution of the program 160 has encountered a breakpoint at a condition location 335, so control continues to block 520 where the debugger 168 finds the condition code 164 that is associated with the condition expression 330 via the condition 450 in the found record. Thus, the debugger 168 discovers that the breakpoint at the condition location 335 is associated with the condition code 164. The debugger 168 further evaluates the condition expression 330 at the condition location 335 by executing the condition code 164, which creates a result (truth or falsehood) of the evaluation. Thus, the debugger 168 executes the condition code 164 in response to discovering that the breakpoint at the condition location 335 is associated with the condition code 164. Evaluating the condition expression 330 at the condition location 335 means that the condition expression 330 is evaluated at the time that the execution of the program 160 is stopped at the condition location 335. The result may be 1 or 0, false or true, or any other result that indicates truth or falsehood of the condition expression 330.

Control then continues to block 525 where the debugger 168 finds the normal breakpoint at the breakpoint location 325 that is associated with the separate condition breakpoint at the separate condition location 335 by accessing the associated breakpoint field 455 in the found record of the separate condition breakpoint, e.g., the record 410.

Control then continues to block 530 where the debugger 168 saves the result 460 of the evaluation of the condition code 164 in the breakpoint record of the associated normal breakpoint (e.g., the record 415). The associated normal breakpoint is set at the breakpoint location 325. Thus, the debugger 168 associates the result 460 of the condition, which is evaluated while execution of the program is at the condition location 335, with the breakpoint location 325.

Control then continues to block 532 where the debugger 168 allows execution of the program 160 to continue (causes execution of the program 160 to continue) without giving control to the user via the debug user interface 200, in response to detecting that the breakpoint at the condition location 335 is a separate condition for the breakpoint at the breakpoint location 325.

Control then returns to block 505, where the debugger 168 receives and processes the next event, as previously described above.

If the determination at block 515 is false, then the breakpoint that was encountered by execution of the program 160 is not at a condition location 335 and is not a separate condition, so control continues to block 535 where the debugger 168 determines whether the encountered breakpoint is at a breakpoint location 325 that has an associated separate condition. The debugger 168 makes the determination of block 535 by checking the type 445 of the breakpoint record associated with the encountered breakpoint. If the type 445 indicates that the breakpoint record is a normal breakpoint with an associated separate condition (e.g., the record 415), then the determination at block 535 is true.

If the determination at block 535 is true, then the breakpoint encountered by the execution of the program 160 is at a breakpoint location 325 that has an associated separate condition 330, which is evaluated at a separate condition location 335, so control continues to block 605 (FIG. 6) where the debugger 168 determines whether the result 460 exists, whether the result 460 is associated with the breakpoint location 325, and whether the result 460 is true. The debugger 168 determines whether the result 460 exists by checking with the result 460 contains a value. The debugger 168 determines whether the result 460 is associated with the breakpoint location 325 by determining whether the result field 460 that contains the value is in the record associated with the encountered breakpoint that has a type 445 of a normal breakpoint with an associated separate condition. The debugger 168 determines whether the result is true by checking whether the value in the result field 460 indicates truth.

If the determination at block 605 is true, then the result 460 exists, the result 460 was previously calculated at a separate condition location 335 that is associated with the breakpoint location 325 of the currently encountered breakpoint, and the result 460 of the separate condition is true, so control continues to block 610 where the debugger 168 halts execution of the program 160 at the breakpoint location 325, presents the debug user interface 200, gives control to the user, and allows the user to issue commands, such as the set breakpoint command 205, the remove breakpoint command 210, the step command 215, the examine storage command 220, and the resume execution command 222, which the debugger 168 processes to cause the next event. Control then returns to block 505 where the debugger 168 receives and processes the next event, as previously described above.

If the determination at block 605 is false, then the result 460 exists but is false or the result 460 does not exist (because the condition location 335 has not yet been encountered by execution of the program 160), so control continues to block 615 where the debugger 168 allows or causes the program 160 to continue executing without presenting the debug user interface 200, so the user does not obtain control and does not have the opportunity to issue the commands to the debugger 168 via the debug user interface 200. Control then returns to block 505 where the debugger 168 receives and processes the next event, as previously described above.

If the determination at block 535 is false, then the encountered breakpoint is not at a breakpoint location 325 that has an associated separate condition 330 at a separate condition location 335, so control continues to block 620 where the debugger 168 determines whether a normal unconditional breakpoint was encountered by execution of the program 160. The debugger 168 makes the determination of block 620 by checking the type field 445 in the breakpoint record whose address 425, program 435, and statement 440 match the location where execution of the program 160 is stopped. The record 405 in the breakpoint table 162 is an example of a normal, unconditional breakpoint.

If the determination at block 620 is true, then the encountered breakpoint is a normal unconditional breakpoint, so control continues to block 610 where the debugger 168 halts execution of the program 160 and presents the debug user interface 200, as previously described above. Control then returns to block 505 where the debugger 168 receives and processes the next event, as previously described above.

If the determination at block 620 is false, then the encountered breakpoint is not a normal unconditional breakpoint, so control continues to block 625 where the debugger 168 determines whether the encountered breakpoint is a normal breakpoint with a condition 330 that is to be evaluated at the breakpoint location 325 (e.g., the breakpoint associated with the breakpoint record 420), i.e., the condition is not separate from the breakpoint location. The debugger 168 makes the determination of block 625 by checking the type field 445 in the breakpoint record whose address 425, program 435, and statement 440 match the location where execution of the program 160 is stopped.

If the determination at block 625 is true, then the encountered breakpoint is a normal breakpoint with a condition, so control continues to block 630 where the debugger 168 executes the condition code 164 (identified by the condition 450), which evaluates the condition expression 330 at the time that the execution of the program 160 is at the breakpoint location 325 and creates the result 460. Control then continues to block 635 where the debugger 168 determines whether the result 460 of the condition expression 330 or condition code 164 indicates that the condition is true (the condition is satisfied or met).

If the determination at block 635 is true, then the result 460 of the evaluation of the condition expression 330 or condition code 164 is true, so control continues to block 610 where the debugger 168 halts execution of the program 160 and presents the debug user interface 200, as previously described above. Control then returns to block 505 where the debugger 168 receives and processes the next event, as previously described above.

If the determination at block 635 is false, then the result 460 of the evaluation of the condition expression 330 or execution of the condition code 164 at the time that execution of the program 160 is at the breakpoint location 325 is false, so control continues to block 615 where the debugger 168 allows or causes the program 160 to continue executing without presenting the debug user interface 200 and without giving control to the user. Control then returns to block 505 where the debugger 168 receives and processes the next event, as previously described above.

If the determination at block 625 is false, then the breakpoint encountered is not a normal breakpoint with a condition, so control continues to block 610 where the debugger 168 halts execution of the program 160 and presents the debug user interface 200, as previously described above.

If the determination at block 510 is false, then the received event is not a hit breakpoint event, so control continues to block 540 where the debugger 168 processes other events, as further described below with reference to FIG. 7. Control then returns to block 505 where the debugger 168 receives and processes the next event, as previously described above.

FIG. 7 depicts a flowchart of further example processing for the debugger 168, according to an embodiment of the invention. Control begins at block 700. Control then continues to block 705 where the debugger 168 determines whether the received event is the remove breakpoint command 210.

If the determination at block 705 is true, then the received event is the remove breakpoint command 210, so control continues to block 710 where the debugger 168 determines whether the breakpoint specified to be removed by the remove breakpoint command 210 is a normal breakpoint with an associated separate condition, e.g., the record 415. The debugger 168 makes the determination at block 710 by determining whether the type 445 of the breakpoint record that is to be removed indicates that the breakpoint is a normal breakpoint with a separate condition.

If the determination at block 710 is true, then the breakpoint to be removed is a normal breakpoint with an associated separate condition breakpoint, so control continues to block 720 where the debugger 168 finds the normal breakpoint at the breakpoint location 325 via the address 425, program 435, and/or statement 440 and finds the separate condition breakpoint at the condition location 335 via the associated breakpoint field 445. Control then continues to block 725 where the debugger 168 removes the normal breakpoint at the breakpoint location 325 from the program 160 and removes the record for the normal breakpoint (e.g., the record 415) from the breakpoint table 162. The debugger 168 replaces the invalid instruction in the program 160 at the breakpoint location 325 with the operation 430 from the normal breakpoint record.

Control then continues to block 730 where the debugger 168 removes the separate condition breakpoint at the condition location 335 from the program 160 by substituting the invalid instruction in the program 160 at the condition location 335 with the operation 430 in the condition breakpoint record, e.g., the record 410. The debugger 168 further removes the record associated with the separate condition breakpoint, e.g., the record 410, from the breakpoint table 162. Control then continues to block 799 where the logic of FIG. 7 returns.

If the determination at block 710 is false, then the breakpoint to be removed is not a normal breakpoint with a separate condition, so control continues to block 715 where the debugger 168 removes the breakpoint from the program 160 and removes the associated record from the breakpoint table 162. Control then continues to block 799 where the logic of FIG. 7 returns.

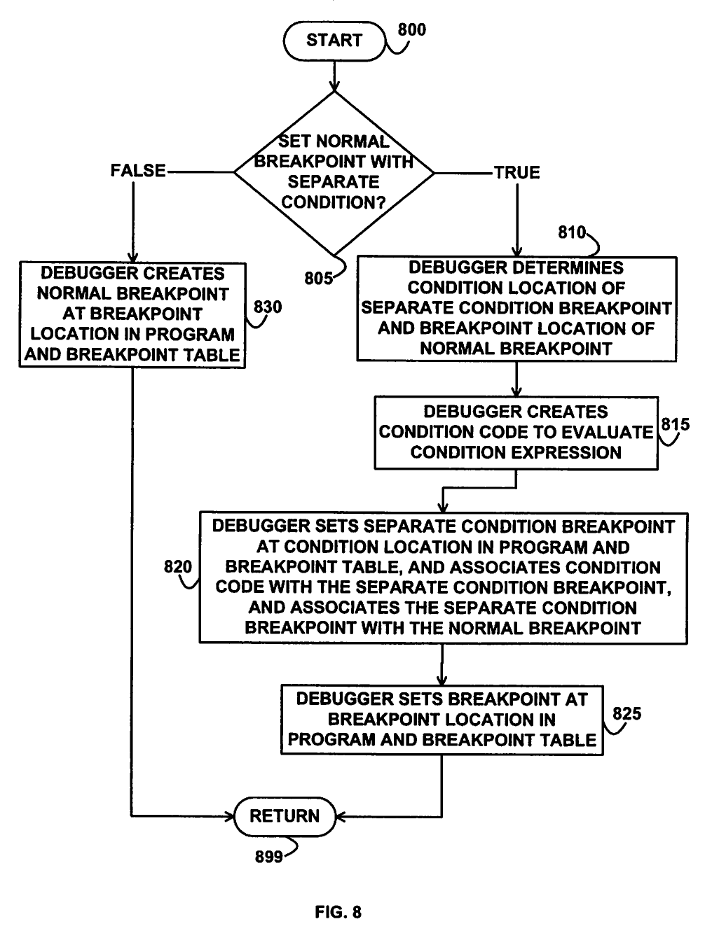

If the determination at block 705 is false, then the received event is not the remove breakpoint command 210, so control continues to block 735 where the debugger 168 determines whether the received event is the set breakpoint command 205. If the determination at block 735 is true, then the received event is a set breakpoint command 205, so control continues to block 740 where the debugger 168 processes the set breakpoint event, as further described below with reference to FIG. 8. Control then continues to block 799 where the logic of FIG. 7 returns.

If the determination at block 735 is false, then the received event is not a set breakpoint command, so control continues to block 745 where the debugger 168 processes other events, such as the step command 215, the examine storage command 220, the resume execution command 222, or any other appropriate event. Control then continues to block 799 where the logic of FIG. 7 returns.

FIG. 8 depicts a flowchart of further example processing for the debugger 168, according to an embodiment of the invention. Control begins at block 800. Control then continues to block 805 where the debugger 168 determines whether the received event includes a set breakpoint command 166 that identifies a breakpoint location 325, a condition expression 330, and a separate condition location 335 that identifies a location in the program 160 where the condition expression 330 is to be evaluated, where the condition location 335 is different from the breakpoint location 325.

If the determination at block 805 is true, then the received event is a set breakpoint command 166 that identifies a breakpoint location 325, a condition expression 330, and a separate condition location 335 that identifies a location in the program 160 where the condition expression 330 is to be evaluated, and the condition location 335 is different from the breakpoint location 325, so control continues to block 810 where the debugger 168 determines the condition location 335 of the separate condition breakpoint and the breakpoint location 325 of a normal breakpoint within the program 160. Control then continues to block 815 where the debugger 168 creates the condition code 164, which when executed evaluates the condition expression 330.

Control then continues to block 820 where the debugger 168 creates a record for the separate condition breakpoint, e.g., the record 410, in the breakpoint table 162. The debugger 168 sets the separate condition breakpoint at the condition location 335 in the program 160 by copying the operation code from the condition location 335 in the program 160 to the operation 430 in the record for the separate condition breakpoint in the breakpoint table 162 and replacing the operation code in the program 160 with an invalid instruction. The debugger 168 sets the condition location 335 in the address 425, the program field 435, and the statement 440 of the separate condition breakpoint record (e.g., the record 410). The debugger 168 sets the type 445 of the separate condition breakpoint, e.g., the record 410, to indicate that the record is for a separate condition. The debugger 168 associates the condition code 164 with the separate condition breakpoint by setting the condition field 450 in the separate condition breakpoint record to describe the condition expression 330 or to point to or indicate the condition code 164.

The debugger 168 creates a record in the breakpoint table 162 for a normal breakpoint with a separate condition at the breakpoint location 325. The debugger 168 associates the separate condition breakpoint with the normal breakpoint by setting the associated breakpoint field 455 in the separate condition record (e.g., the record 410) to point to or indicate the normal breakpoint record (e.g., the record 415).

Control then continues to block 825 where the debugger 168 sets a normal breakpoint in the program 160 at the normal breakpoint location 325 by copying the operation code from the normal breakpoint location 325 in the program 160 to the operation 430 in the record for the normal breakpoint (e.g., the record 415) in the breakpoint table 162 and replacing the operation code in the program 160 with an invalid instruction. The debugger 168 sets the breakpoint location 325 in the address 425, the program 435, and the statement 440 of the normal breakpoint record (e.g., the record 415). The debugger 168 sets the type 445 of the normal breakpoint record (e.g., the record 415) to indicate that the record is for a normal breakpoint with a separate condition. The debugger 168 associates the normal breakpoint record (e.g., the record 415) with the separate condition breakpoint record (e.g., the record 410) by setting the associated breakpoint field 445 in the normal breakpoint record (e.g., the record 415) to point to or indicate the separate condition breakpoint record (e.g., the record 410).

Control then continues to block 899 where the logic of FIG. 8 returns.

If the determination at block 805 is false, then the received event is a normal breakpoint or a normal breakpoint with a condition at the breakpoint location, so control continues to block 830 where the debugger 168 creates the normal breakpoint at the normal breakpoint location 325 in the program 160 and creates a normal breakpoint record in the breakpoint table 162, such as the breakpoint indicated in the records 405 or 420 of the breakpoint table 162. Control then continues to block 899 where the logic of FIG. 8 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
determining whether a breakpoint command identifies a breakpoint location, a condition expression, and a condition location, wherein the condition location is separate from the breakpoint location;
if the determining is true and execution of a program reaches the condition location, evaluating the condition expression at the condition location, saving a result of the evaluating, and associating the result with the breakpoint location;
in response to execution of the program reaching the breakpoint location, deciding whether the result exists and is associated with the breakpoint location; and
if the deciding is true and the result of the condition expression is true, halting execution of the program at the breakpoint location.

2. The method of claim 1, further comprising:
if the deciding is true and the result of the condition expression is false, allowing the program to continue executing at the breakpoint location.

3. The method of claim 1, wherein the condition expression comprises a variable that is out-of-scope at the breakpoint location.

4. The method of claim 1, wherein the condition expression comprises an identification of a storage location that is unaddressable while execution of the program is at the breakpoint location.

5. The method of claim 4, wherein the storage location is further addressable while execution of the program is at the condition location.

6. The method of claim 1, further comprising:
if the determining is true, setting a first breakpoint at the condition location, creating condition code based on the condition expression, associating the condition code with the first breakpoint, setting a second breakpoint at the breakpoint location, and storing an indication that the first breakpoint is a condition for the second breakpoint.

7. The method of claim 6, further comprising:
in response to the program encountering the first breakpoint, discovering that the first breakpoint is associated with the condition code.

8. The method of claim 7, wherein the evaluating further comprises:
in response to the discovering, executing the condition code, wherein the condition code evaluates the condition expression and creates the result.

9. The method of claim 8, further comprising:
detecting the indication that the first breakpoint is a condition for the second breakpoint; and
in response to the detecting, continuing execution of the program.

10. A signal-bearing medium encoded with instructions, wherein the instructions when executed comprise:
determining whether a breakpoint command identifies a breakpoint location, a condition expression, and a condition location, wherein the condition location is separate from the breakpoint location;
if the determining is true and execution of a program reaches the condition location, evaluating the condition expression at the condition location, saving a result of the evaluating, and associating the result with the breakpoint location;
in response to execution of the program reaching the breakpoint location, deciding whether the result exists and is associated with the breakpoint location;
if the deciding is true and the result of the condition expression is true, halting execution of the program at the breakpoint location; and
if the deciding is true and the result of the condition expression is false, allowing the program to continue executing at the breakpoint location.

11. The signal-bearing medium of claim 10, wherein the condition expression comprises a variable that is out-of-scope at the breakpoint location.

12. The signal-bearing medium of claim 10, wherein the condition expression comprises an identification of a storage location that that is unaddressable while execution of the program is at the breakpoint location and addressable while execution of the program is at the condition location.

13. The signal-bearing medium of claim 10, further comprising:
if the determining is true, setting a first breakpoint at the condition location, creating condition code based on the condition expression, associating the condition code with the first breakpoint, and setting a second breakpoint at the breakpoint location, and storing an indication that the first breakpoint is a condition for the second breakpoint; and
in response to the program encountering the first breakpoint, discovering that the first breakpoint is associated with the condition code.

14. The signal-bearing medium of claim 13, wherein the evaluating further comprises:
in response to the discovering, executing the condition code, wherein the condition code evaluates the condition expression and creates the result.

15. The signal-bearing medium of claim 14, further comprising:
detecting the indication that the first breakpoint is a condition for the second breakpoint; and
in response to the detecting, continuing execution of the program.

16. A method for configuring a computer, comprising:
configuring the computer to determine whether a breakpoint command identifies a breakpoint location, a condition expression, and a condition location, wherein the condition location is separate from the breakpoint location;
configuring the computer to, if the determining is true and execution of a program reaches the condition location, evaluate the condition expression at the condition location, saving a result of the evaluating, and associating the result with the breakpoint location;
configuring the computer to, in response to execution of the program reaching the breakpoint location, decide whether the result exists and is associated with the breakpoint location;
configuring the computer to, if the deciding is true and the result of the condition expression is true, halt execution of the program at the breakpoint location;
configuring the computer to, if the deciding is true and the result of the condition expression is false, allow the program to continue executing at the breakpoint location; and
configuring the computer to, if the deciding is false, allow the program to continue executing at the breakpoint location.

17. The method of claim 16, wherein the condition expression comprises a variable that is modified by execution of the program at an intervening location between the condition location and the breakpoint location.

18. The method of claim 16, wherein the condition expression comprises an identification of a storage location that that is unaddressable while execution of the program is at the breakpoint location and addressable while execution of the program is at the condition location.

19. The method of claim 16, further comprising:
configuring the computer to, if the determining is true, set a first breakpoint at the condition location, create condition code based on the condition expression, associate the condition code with the first breakpoint, set a second breakpoint at the breakpoint location, and store an indication that the first breakpoint is a condition for the second breakpoint; and
configuring the computer to, in response to the program encountering the first breakpoint, discover that the first breakpoint is associated with the condition code.

20. The method of claim 19, further comprising:
configuring the computer to, in response to the discovering, execute the condition code, wherein the condition code evaluates the condition expression and creates the result;
configuring the computer to, detect the indication that the first breakpoint is a condition for the second breakpoint; and
configuring the computer to, in response to the detecting, continue execution of the program.
